(19) United States
(12) Patent Application Publication
(10) Pub. No.: US 2016/0019593 A1
(43) Pub. Date: Jan. 21, 2016

(54) COMPUTER-IMPLEMENTED METHOD AND SYSTEM FOR EPHEMERAL ADVERTISING

(71) Applicants: Marvin IGELMAN, Thornhill (CA); Steve CHUNG, San Francisco, CA (US); Jungsoo PARK, Seoul (KR)

(72) Inventors: Marvin IGELMAN, Thornhill (CA); Steve CHUNG, San Francisco, CA (US); Jungsoo PARK, Seoul (KR)

(21) Appl. No.: 14/749,062

(22) Filed: Jun. 24, 2015

Related U.S. Application Data
(60) Provisional application No. 62/016,946, filed on Jun. 25, 2014.

(51) Int. Cl. G06Q 30/02

(52) U.S. Cl. CPC G06Q 30/0264; G06Q 30/0272

(57) ABSTRACT

Systems and methods for presenting ephemeral promotions to consumers are described, in which a time-limited promotion is displayed alongside consumer-directed content on a computing device used by a consumer. The time-limited promotion is ephemeral and disappears if the computing device does not detect customer engagement of the promotion within a time limit for the promotion. An advertising server transmits an advertisement, a promotion, a time limit setting and instructions over a network to the computing. The instructions are configured to cause the computing device to display the advertisement near the consumer-directed content, to display the promotion upon the computing device detecting consumer engagement with the advertisement within the time limit and to terminate display of the advertisement if the computing device does not detect the consumer engagement within the time limit. Further systems and methods are set out.

### TECHNICAL FIELD

The following relates generally to digital advertising and more specifically to computer-implemented systems and methods for presentation of ephemeral advertisements on computing devices.

### CROSS-REFERENCE TO RELATED APPLICATIONS

The application claims the benefit of U.S. Provisional Patent Application No. 62/016,946 filed Jun. 25, 2014, the entire disclosure of which is incorporated herein by reference.

### BACKGROUND

Many websites and Software as a Service (SaaS) platforms rely on advertising to generate revenue. Consumers commonly engage with such websites and platforms through their computing devices, such as, for example, desktop and laptop computers, and mobile devices, such as, for example, mobile telephones and tablets.

### SUMMARY

In one aspect, a computer-implemented method for displaying an ephemeral advertisement in association with consumer-directed content is provided, the method comprising: generating, by an ephemeral advertising definition manager, an ephemeral advertising definition comprising an advertisement, a time limit identifier defining a time limit, and promotion parameters defining a promotion, the ephemeral advertising definition being configured to cause a consumer computing device for a consumer to: (i) display the advertisement; (ii) display the promotion upon the consumer computing device detecting consumer engagement with the advertisement within the time limit; and (iii) terminate display of the advertisement upon the consumer computing device not detecting consumer engagement with the advertisement within the time limit; obtaining, by a server, the ephemeral advertising definition from the ephemeral advertising definition manager and transmitting the ephemeral advertising definition to the consumer computing device.

A system for displaying an ephemeral advertisement in association with consumer-directed content, the system comprising: an ephemeral advertising definition manager, the ephemeral advertising definition manager being configured to generate an ephemeral advertising definition comprising an advertisement, a time limit identifier defining a time limit, and promotion parameters defining a promotion, the ephemeral advertising definition being configured to cause the consumer computing device to: (a) display the advertisement; (b) display the promotion upon the consumer computing device detecting consumer engagement with the advertisement within the time limit; and (c) terminate display of the advertisement if the consumer computing device does not detect consumer engagement with the advertisement within the time limit; and a server in communication with the ephemeral advertising definition manager to obtain the ephemeral advertising definition from the ephemeral advertising definition manager and transmit the ephemeral advertisement unit to the consumer computing device.

A server system for displaying an ephemeral advertisement in association with consumer-directed content, the server system comprising an advertising server configured to obtain from an ephemeral advertising definition manager and transmit to a consumer computing device for a consumer an ephemeral advertising definition comprising an advertisement, a time limit identifier defining a time limit, and promotion parameters defining a promotion, the ephemeral advertising definition being configured to cause the consumer computing device to: display the advertisement; and display the promotion upon the consumer computing device detecting consumer engagement with the advertisement within the time limit; and terminate display of the advertisement if the consumer computing device does not detect consumer engagement with the advertisement within the time limit.

These and other aspects are contemplated and described herein. It will be appreciated that the foregoing summary sets out representative aspects of systems and methods for displaying ephemeral advertisements on a computing device for a consumer, in order to assist skilled readers in understanding the following detailed description.

### DESCRIPTION OF THE DRAWINGS

A greater understanding of the embodiments will be had with reference to the Figures, in which:

FIG. 1 is an architecture diagram of a computing device;

FIG. 2 is an architecture diagram of a system for presenting ephemeral advertisements to a consumer;

FIG. 3 is a flowchart depicting a method for generating advertising campaigns to present ephemeral advertisements to a consumer;

FIGS. 4 is a flowchart depicting consumer interaction with an ephemeral advertisement; and

FIGS. 5a to 5c show alternate embodiments of a user interface for presenting ephemeral advertisements to a consumer.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practised without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine, manager or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

As previously described, many websites and Software as a Service (SaaS) platforms rely on advertising displayed in conjunction with consumer-directed content to generate revenue, and content consumers commonly engage with such websites and platforms through their mobile devices, such as, for example, mobile telephones and tablets.

It has been found that a particular challenge relevant to digital advertising is motivating consumers of consumer-directed content to engage with advertising displayed in conjunction with the consumer-directed content. Consumer-directed content may comprise, for example, newspaper articles, social networking sites and other content published for viewing by consumers. The relatively small screen sizes of many mobile devices used by consumers to view consumer-directed content may exacerbate this challenge, because the amount of information on the consumer's screen may be less than on a typical desktop computer or similar interface. In an exemplary scenario, a consumer may be reading an online newspaper article on his smart phone. A banner ad located midway through the article may be presented to the consumer when he reaches that section. Even though the consumer may be interested in the subject matter of the banner ad, his desire to finish reading the article may overcome his interest in engaging with the banner ad. By the time he has finished the article, he may have forgotten about the banner ad that previously had caught his interest.

It has been found further that even banner ads utilizing dedicated screen space may suffer from unsatisfactory consumer engagement. For example, at least some third party mobile applications (commonly referred to as “apps”) dedicate an upper or lower portion of the screen to a banner ad; however, many consumers may ignore such ads.

In aspects, systems and methods set out herein are directed to applying a predefined time limit to advertisements in order to impart “ephemerality” for such advertisements. Ephemerality is directed to imparting in the consumer viewing such promotions a sensation that the promotion underlying the advertisement is fleeting, which may give rise to a sense of urgency capable of compelling the consumer to engage with the advertisement.

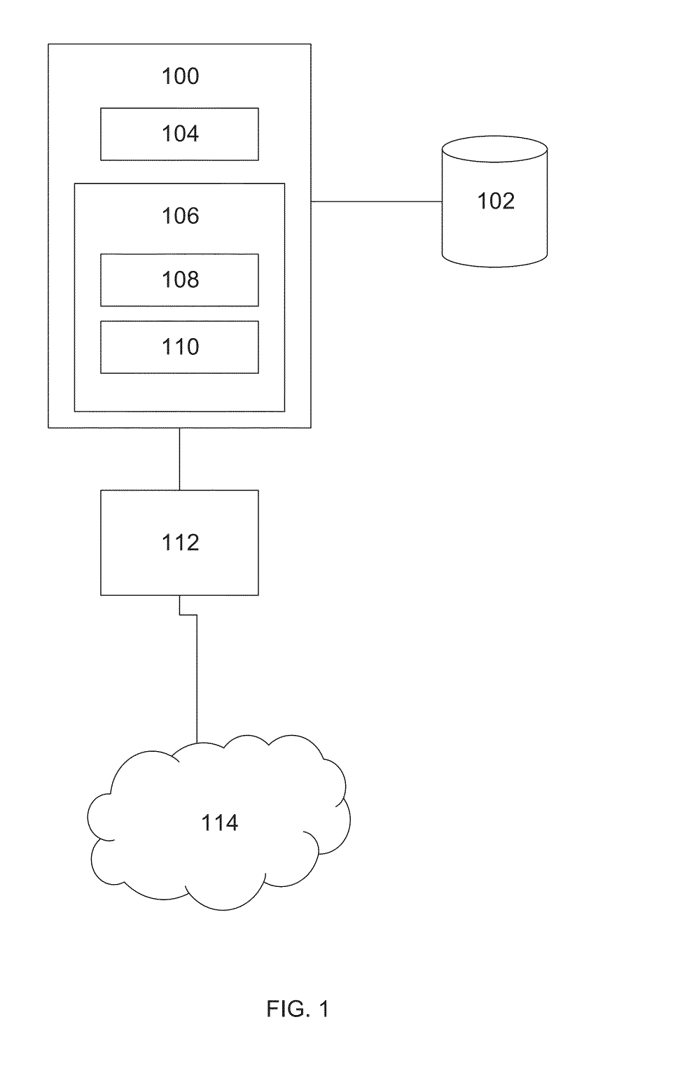

Referring now to FIG. 1, a computing device 100 for a user (a consumer) is shown. The computing device 100 comprises or is linked to a user interface 106, a memory 102 and a processor 104. The memory has stored thereon computer instructions which, when executed by the processor, cause the processor to implement computer programs that perform the operations described herein. The computer programs may comprise an operating system, and one or more user applications or programs.

Aspects of the computer programs stored in the memory 102 may comprise outputting information to the user via the user interface 106. The output may be provided by a display 108 of the user interface 106. The user interface 106 may also comprise one or more input devices 110, such as, for example, physical buttons, switches, a mouse, a stylus, virtual buttons or keyboard (for example, provided by the display of a touchscreen interface), a camera, microphone, accelerometer, gyroscope, or any other input devices by which a user can provide a command to the computing device 100.

The computing device 100 may be embodied by a desktop computer, laptop computer, tablet device, mobile telephone or other suitable device as is readily apparent. In embodiments, the user interface 106 comprises a touchscreen, such that at least one of the input devices 110 is integrated with the display as an element of the user interface 106.

The computing device 100 may further comprise a network unit 112 providing, for example, Wi-Fi, cellular, 3G, 4G, Bluetooth and/or LTE connectivity by the device to a network 114, such as, for example, the Internet or a local intranet.

One or more of the aforementioned components of the computing device 100 may be in communication with, and situated remotely from, the computing device 100.

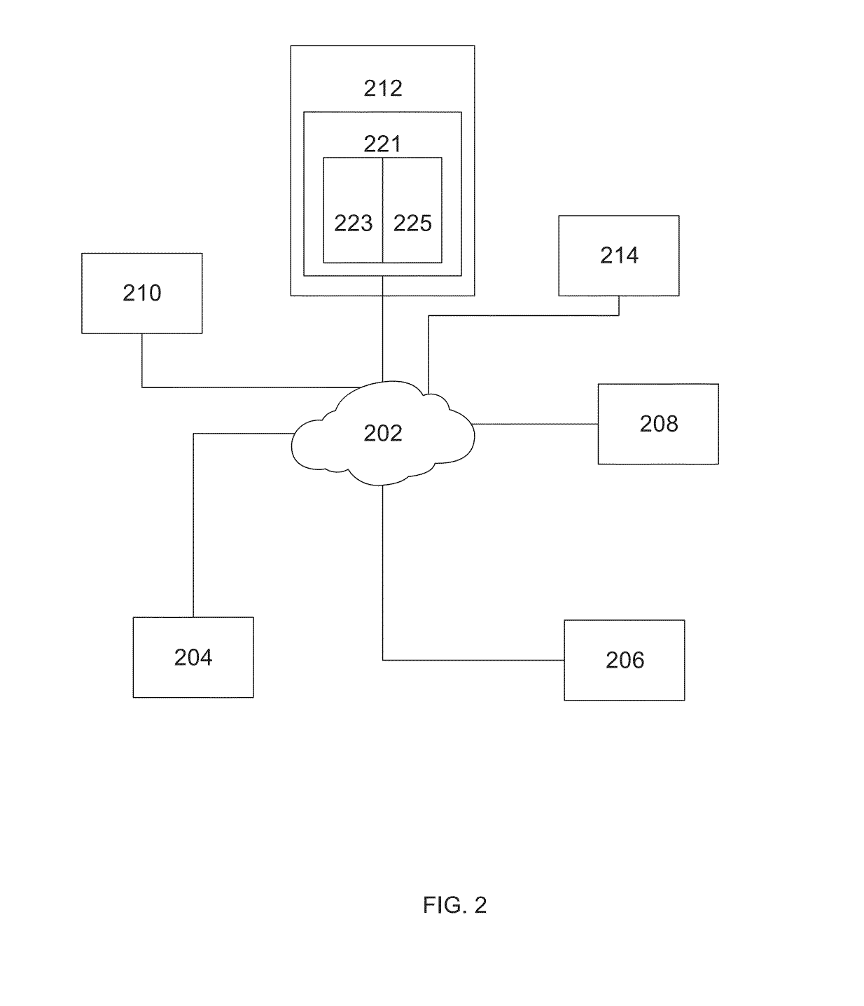

Referring now to FIG. 2, embodiments of a system for displaying ephemeral advertising to a consumer are illustrated. The system comprises an ad server 208 which disseminates advertising content across a network 202 to consumer computing devices 204. The network 202 links one more consumer computing devices 204, ad servers 208, advertiser computing devices 210, and publisher servers 206, each of which respectively enables access to the network 202 by consumers, advertisers and content publishers through their respective computing devices. The consumers, advertisers and content publishers may be referred to collectively herein as ‘users’. Each of the aforementioned devices may be embodied by the computing device 100, shown in FIG. 1, or by some other suitable computing device.

The advertiser computing device 210 may communicate with an ephemeral advertising definition (‘EAD’) server 212 to generate ephemeral advertising campaigns as described herein in greater detail.

In embodiments, the network 202 comprises social networking functionality provided by one or more social media servers 214. The social networking functionality may support activity streams, including posting, hosting and sharing of content, as described herein in greater detail.

The EAD server 212 hosts an EAD manager 221 configured to generate and transmit ephemeral advertisements in the form of EADs. An EAD comprises an advertisement, promotion parameters, and a time limit identifier, and is configured to cause a consumer device to display an ephemeral advertising campaign in accordance with campaign and publication parameters, embodied by ephemeral advertising definitions. The promotion parameters may, for example, comprise preconfigured discounts applicable to particular identified goods and services of the advertiser.

The EAD manager 221 comprises: (1) an EAD campaign builder 223 configured to generate ephemeral advertising campaigns based on campaign parameters selected by an advertiser; and (2) an EAD publishing module 225 configured to control which consumers are to receive which ephemeral advertising campaigns, based on publishing parameters selected by the advertiser. The EAD manager 221 allows advertisers and/or content publishers, via their respective computing devices, to build ephemeral advertising campaigns. Campaign generation may involve generating new ephemeral advertising campaigns or applying ephemerality to existing non-ephemeral advertising campaigns, as described herein in greater detail. Although the EAD manager 221 is shown in FIG. 2 as being hosted in the EAD server 212 and accessible by the advertiser computing device 210 and content publisher server 206, the EAD manager 221 may be hosted instead by the advertiser computing device 210 or any other computing device controlled by an advertiser or content publisher wishing to generate ephemeral advertising campaigns. If the EAD manager 221 is hosted in the EAD server 212 over the network 202, advertisers, through their respective computing devices, may access the EAD manager 221 as a cloud based service such that the EAD manager 221 is accessible through a network-based interface, such as, for example, a website, displayed on the user's computing device through, for example, a web browser.

Advertisers may use the EAD manager 221 to generate advertising campaigns for displaying ephemeral advertisements in association with consumer-directed content. Such an advertising campaign comprises dissemination of EADs configured to cause a consumer computing device to: (a) display the advertisement from an EAD in proximity to the consumer-directed content being displayed on the consumer computing device; (b) if the consumer does not engage with the advertisement within the time limit defined by the time limit identifier of the EAD, terminate display of the advertisement; and (c) if the consumer does engage with the advertisement within the time limit, display the promotion, as defined by promotion parameters, from the EAD.

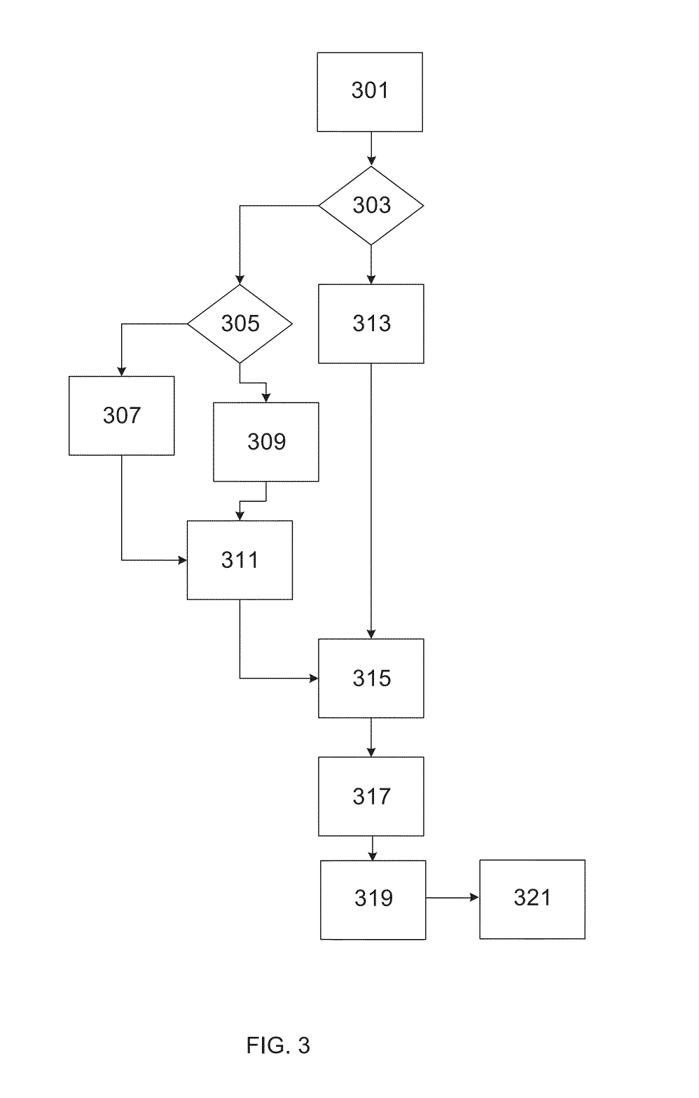

In FIG. 3 a flowchart illustrates a method for generating and publishing an ephemeral advertising campaign. At block 301 an advertiser computing device registers with the EAD manager's EAD campaign builder 223. At block 303, the EAD campaign builder 223 receives instructions from an advertiser computing device 210 in communication with the EAD manager 221. The instructions indicate whether the advertiser wishes to apply ephemerality to an existing advertising campaign or to create a new ephemeral advertising campaign. If the advertiser selects the creation of a new ephemeral advertising campaign, the advertiser is prompted to select, at block 305, whether to generate the new ephemeral advertising campaign from an existing campaign template or to generate a new template.

If the advertiser selects design of a new campaign template, at block 307 the EAD manager 221 issues a prompt to the advertiser computing unit directing the advertiser to create the new template. Templates may comprise, for example, defined imagery, layouts, design features, fonts and functionality. Alternatively, the advertiser may upload a campaign template from the advertiser's repository or third parties to the EAD campaign builder 223.

If at block 305 the advertiser has instead selected to use a pre-existing EAD template, at block 309 the EAD manager 221 prompts the advertiser to select one of the pre-existing templates available to the EAD manager 221, for example in a memory accessible to the EAD manager 221.

After the advertiser has selected or generated a template at blocks 309 or 307, respectively, the EAD manager 221 prompts the advertiser to select promotion parameters for the campaign, at block 311. The promotion parameters the advertiser selects or is required to select are determined as a function of the templates. Promotion parameters may comprise, for instance, at least one discount rate for goods and services being promoted in the campaign, location awareness and other suitable details.

If at block 303 the advertiser has selected to add ephemerality to an existing non-ephemeral advertising campaign, at block 313 the EAD manager 221 prompts the advertiser to select the existing non-ephemeral campaign to which the EAD manager 221 is to apply ephemerality.

Whether the advertiser has selected to produce a new ephemeral advertising campaign or to apply ephemerality to an existing non-ephemeral campaign, the EAD campaign builder 223 generates a campaign. In either case, at block 315 the EAD publishing module 225 prompts the advertiser to select a publishing point or select publishing criteria. A publishing point may comprise, for example, an advertising network, or a specific content publisher. Publishing criteria may comprise, for example, consumer demographic information, such as, for example, age, gender, income or purchasing habits. The advertiser may select publishing criteria which cause the EAD publishing module 225 to further refine or restrict the advertising campaign target by, for example, limiting the advertising campaign to a specified geographical location or date.

At block 317 the EAD publication module 225 prompts the advertiser to select the ephemerality parameters to apply to the advertising campaign, such as, for example, a time limit, and/or a frequency at which the advertisement in an EAD for the advertising campaign is to be displayed.

At block 319, the advertiser selects cost parameters for the campaign. Cost parameters may comprise, for example, cost per click, click through rate, cost per action, conversion, and a total budget for the advertising campaign; other parameters may be defined.

At block 321, the EAD campaign manager 221 generates the campaign. Once the EAD manager 221 has generated the campaign based on parameters selected by the advertiser, the EAD manager 221 transmits the advertising campaign to the ad server. The ad server, in turn, disseminates the EADs to consumer computing devices 204 in accordance with the publication parameters in the advertising campaign. In embodiments, the EAD interacts with application programming interfaces (APIs) of various advertising delivery systems which are preconfigured to place advertisements in consumer-directed content displayed on consumer computing devices 204.

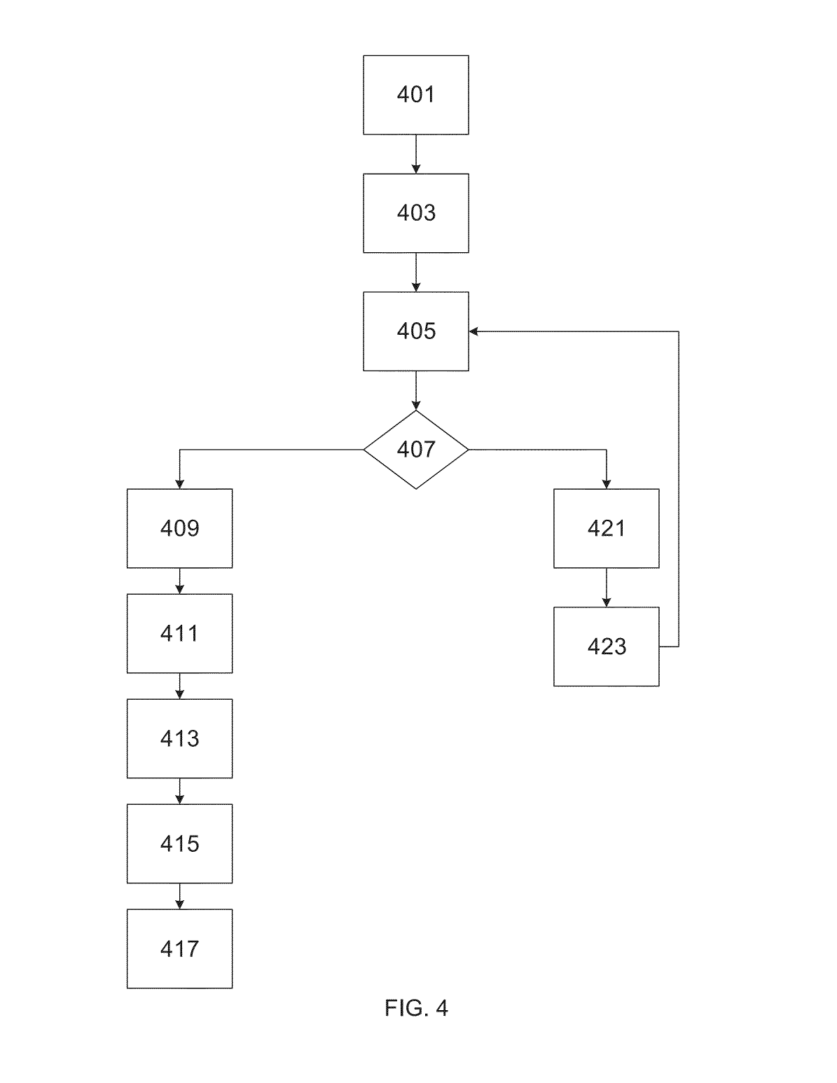

Referring to FIG. 4, a flowchart illustrates aspects of consumer engagement with an ephemeral advertisement. At block 401 the consumer causes consumer-directed content from the publisher server 206 to be displayed on the consumer's computing device 204 by, for example, navigating to a web page or opening an application that displays retrieved consumer-directed content. At block 403 the consumer computing device 204 displays the consumer-directed content to the consumer. It will be appreciated that when the consumer computing device 204 accesses the consumer-directed content from, for example, the publisher server 206, the consumer-directed content may be configured to direct the consumer computing device 204 to fetch EADs from, for example, the ad server 208. At block 405, the consumer computing device 204 fetches the EAD from the EAD manager 221, and the EAD causes the consumer computing device 204 to display the advertisement defined by the EAD in conjunction with the consumer-directed content.

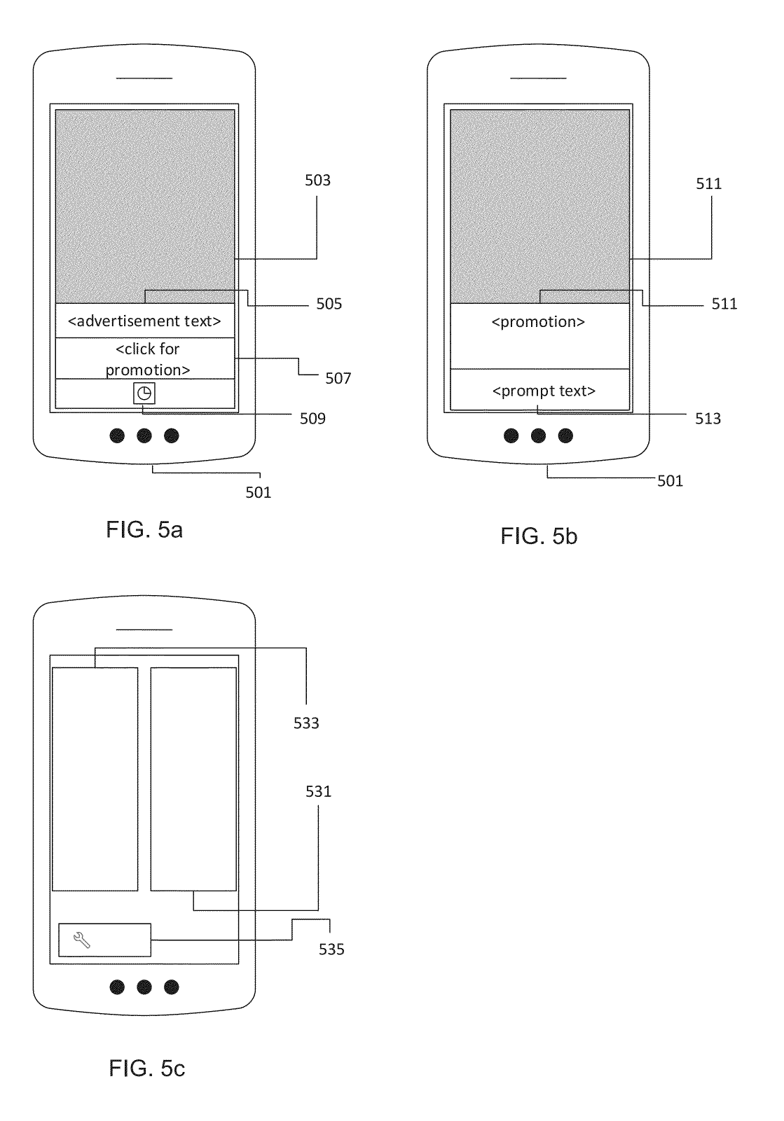

In FIG. 5a, an embodiment of a consumer computing device 204 is shown. The consumer computing device may be, for example, a smart phone 501, as shown. The smart phone 501 is shown displaying consumer-directed content 503 requested by the consumer using the smartphone 501. The smart phone 501 also displays an advertisement 505 in association with the consumer-directed content. In the depicted embodiment, the advertisement 505 presents certain details concerning an advertiser's promotion, but the promotion itself is obscured, for example, by a message 507 inviting the consumer to select the advertisement 505 to obtain more details for the promotion. For example, the advertisement 505 may indicate that a given seller is offering a promotion, but the extent of the promotion may be obscured. The identity of the seller may be obscured or displayed, depending on the parameters for the campaign. A timer 509 may be displayed in conjunction with the advertisement 505 to indicate the remaining time to view the promotion before it becomes unavailable. The remaining time is calculated based on the time limit defined in the time limit identifier for the EAD.

Initially, the advertisement may present no details concerning the promotion. Instead, the advertisement 505 may be displayed as an obscured, i.e., blurred image of the underlying promotion. The advertisement 505 may be blurred to an extent that all elements of the underlying promotion are indiscernible, or to an extent that some elements, such as, for example, the seller's logo, are discernible. Obscuring some or all elements of the advertisement 505 may give the consumer a sense that desirable information underlies the advertisement.

Referring again to FIG. 4, at block 407 the consumer either does or does not engage with the advertisement before the expiration of the time limit. In embodiments, the consumer selects the advertisement. The consumer may engage with the advertisement by, for example, clicking on the advertisement or an element displayed therein. If the consumer selects the advertisement, at block 409 the consumer computing device 204 displays a promotion (and/or, for example, further details concerning the promotion) and a prompt inviting the consumer to redeem the promotion by selecting a link displayed in conjunction with the promotion.

In FIG. 5b the smart phone 501 is shown displaying the promotion 511, as well as an example of a prompt 513 inviting the consumer to redeem the promotion for a coupon.

Referring to FIG. 5 and once again to FIG. 4, at block 411 the consumer clicks on the promotion 511, directing the consumer, at block 413, to a landing page displaying a redeemable coupon. At block 415, the landing page 531 displays a redeemable coupon 533, as well as a toolbar 535 enabling the consumer to transmit the coupon or promotion to others. The consumer may choose to share the coupon or promotion with others in an electronic message, such as, for example, an e-mail or SMS, or to disseminate the coupon or promotion to a social network for which she has a social networking profile. The electronic message comprises another EAD requiring the recipient to undergo a similar operation as the previously described operation the sender, i.e., the initial consumer, was required to undergo.

If, at block 407, the consumer does not select the advertisement within the time limit, the consumer device may display a message at block 421 advising the consumer that the he has missed the promotion. In embodiments, some or all of the obscured portions of the promotion are also revealed, thereby indicating to the consumer what promotion he has missed by not selecting the advertisement at block 407. At this point, the consumer computing device 204 may load a new EAD by undergoing the steps defined in block 405 and onward. In embodiments, the EAD comprises an additional time setting configured to cause the consumer device to display a new advertisement after a time limit, as shown at block 423, instead of immediately after displaying the message displayed at block 421. In further embodiments, the EAD may comprise settings to cause the consumer computing device to increase the frequency at which new advertisements are presented in response to longer periods of consumer inactivity.

In embodiments, instead of, or in addition to, the previously described landing page, the coupon could be delivered or otherwise pushed to the consumer by, for example, SMS, e-mail or other electronic messaging medium.

Although the foregoing has been described with reference to certain specific embodiments, various modifications thereto will be apparent to those skilled in the art without departing from the spirit and scope of the invention as outlined in the appended claims. The entire disclosures of all references recited above are incorporated herein by reference.

1. A computer-implemented method for displaying an ephemeral advertisement in association with consumer-directed content, the method comprising:
(a) generating, by an ephemeral advertising definition manager, an ephemeral advertising definition comprising an advertisement, a time limit identifier defining a time limit, and promotion parameters defining a promotion, the ephemeral advertising definition being configured to cause a consumer computing device for a consumer to:
(i) display the advertisement;
(ii) display the promotion upon the consumer computing device detecting consumer engagement with the advertisement within the time limit; and
(iii) terminate display of the advertisement upon the consumer computing device not detecting consumer engagement with the advertisement within the time limit;
(b) obtaining, by a server, the ephemeral advertising definition from the ephemeral advertising definition manager and transmitting the ephemeral advertising definition to the consumer computing device.

2. The computer-implemented method of claim 1, wherein the ephemeral advertising definition is further configured to cause the consumer computing device to display an amount of time remaining in the time limit.

3. The computer-implemented method of claim 1, wherein the ephemeral advertising definition is further configured to cause the consumer computing device to display another advertisement upon terminating display of the advertisement.

4. The computer-implemented method of claim 1, the method further comprising the ephemeral advertising definition manager generating and transmitting at least one prompt to an advertiser computing device to request from an advertiser using the advertiser computing device to select the promotion parameters for the ephemeral advertising definition.

5. The computer-implemented method of claim 1, wherein the ephemeral advertising definition is configured to further cause the consumer computing device to temporarily display the promotion if the consumer computing device does not detect consumer engagement with the advertisement within the time limit, and wherein the promotion cannot be selected by the consumer.

6. The computer-implemented method of claim 1, wherein the ephemeral advertising definition manager causes the consumer computing device to display part of the promotion within the advertisement prior to detecting consumer engagement with the advertisement.

7. A system for displaying an ephemeral advertisement in association with consumer-directed content, the system comprising:
an ephemeral advertising definition manager, the ephemeral advertising definition manager being configured to generate an ephemeral advertising definition comprising an advertisement, a time limit identifier defining a time limit, and promotion parameters defining a promotion, the ephemeral advertising definition being configured to cause the consumer computing device to:
(a) display the advertisement;
(b) display the promotion upon the consumer computing device detecting consumer engagement with the advertisement within the time limit; and
(c) terminate display of the advertisement if the consumer computing device does not detect consumer engagement with the advertisement within the time limit; and
a server in communication with the ephemeral advertising definition manager to obtain the ephemeral advertising definition from the ephemeral advertising definition manager and transmit the ephemeral advertisement unit to the consumer computing device.

8. The system of claim 7, wherein the ephemeral advertising definition is further configured to cause the consumer computing device to display an amount of time remaining in the time limit.

9. The system of claim 7, wherein the ephemeral advertising definition is further configured to cause the consumer computing device to display another advertisement upon terminating display of the advertisement.

10. The system of claim 7, wherein the ephemeral advertising definition manager is configured to generate and transmit at least one prompt to an advertiser computing device to request from an advertiser using the advertiser computing device to select parameters for the ephemeral advertising definition.

11. The system of claim 7, wherein the ephemeral advertising definition is configured to further cause the consumer computing device to temporarily display the promotion if the consumer computing device does not detect consumer engagement with the advertisement within the time limit, and wherein the promotion cannot be selected by the consumer.

12. The system of claim 7, wherein the ephemeral advertising definition causes the consumer computing device to display part of the promotion within the advertisement prior to detecting consumer engagement with the advertisement.

13. A server system for displaying an ephemeral advertisement in association with consumer-directed content, the server system comprising an advertising server configured to obtain from an ephemeral advertising definition manager and transmit to a consumer computing device for a consumer an ephemeral advertising definition comprising an advertisement, a time limit identifier defining a time limit, and promotion parameters defining a promotion, the ephemeral advertising definition being configured to cause the consumer computing device to:
(a) display the advertisement; and
(b) display the promotion upon the consumer computing device detecting consumer engagement with the advertisement within the time limit; and
(c) terminate display of the advertisement if the consumer computing device does not detect consumer engagement with the advertisement within the time limit.

14. The server system of claim 13, wherein the ephemeral advertising definition is further configured to cause the consumer computing device to display an amount of time remaining in the time limit.

15. The server system of claim 13, wherein the ephemeral advertising definition is further configured to cause the consumer computing device to display another advertisement upon terminating display of the advertisement.

16. The server system of claim 13, wherein the ephemeral advertising definition manager is configured to generate and transmit at least one prompt to an advertiser computing device to request from an advertiser using the advertiser computing device to select parameters for the ephemeral advertising definition.

17. The server system of claim 13, wherein the ephemeral advertising definition is configured to further cause the consumer computing device to temporarily display the promotion if the consumer computing device does not detect consumer engagement with the advertisement within the time limit, and wherein the promotion cannot be selected by the consumer.

18. The server system of claim 13, wherein the ephemeral advertising definition causes the consumer computing device to display part of the promotion within the advertisement prior to detecting consumer engagement with the advertisement.
